(19) United States
(12) Patent Application Publication
(10) Pub. No.: US 2008/0210073 A1
(43) Pub. Date: Sep. 4, 2008

(54) MITER SAW

(75) Inventor: Changning Zhang, Nanjing (CN)

Correspondence Address: GREENBERG TRAURIG, LLP, 77 WEST WACKER DRIVE, SUITE 2500, CHICAGO, IL, 60601-1732, US

(73) Assignee: CHERVON LIMITED, Kwai Chung (HK)

(21) Appl. No.: 12/018,998

(22) Filed: Jan. 24, 2008

(30) Foreign Application Priority Data
Feb. 16, 2007 (CN) 200720034571.2

(51) Int. Cl. B23D 45/04

(52) U.S. Cl. 83/471.3

(57) ABSTRACT

A miter saw having a base, a turntable mounted on the base, a support provided on a first end of the turntable, a pivot member connected to the support for pivotal movement about a first horizontal axis, a supporting arm connected to the pivot member for pivoting about a second horizontal axis which is generally perpendicular to the first horizontal axis, a cutting assemble fixedly mounted on the supporting arm, and a bevel locking mechanism provided for locking the pivot member to the support. The bevel locking mechanism has a lever mounted to a second end of the turntable opposite the first end, a flexible elongate element with one end winding around the lever and the other end connected to a bevel locking shaft which is connected between the pivot member and the support.

### BACKGROUND

The present invention generally relates to miter saws and, more particularly, to cutting angle locking and locating mechanisms for miter saws.

A miter saw typically includes a base for supporting a workpiece and a turntable mounted on the base for rotating about a vertical axis. A support is mounted at the rear of the turntable and a pivot mechanism is connected to the support for pivotal movement about a first horizontal axis which generally lies in a supporting surface of the turntable. A supporting arm is connected to the pivot mechanism for pivoting about a second horizontal axis which is generally perpendicular to the first horizontal axis. A cutting assembly is fixedly mounted on the supporting arm for pivoting about the second horizontal axis between a cutting position, whereat the cutting assembly is in a lower position close to the turntable, and a non-cutting position, whereat the cutting assembly is in an upper position away from the turntable.

During general cutting operations there are usually demands for bevel cutting, miter cutting, and various combinations of bevel cutting and miter cutting. Thus, mechanisms are used to adjust and lock the cutting assembly and/or the turntable in a required angular position. A bevel locking actuator for the miter saw is often disposed at the turntable near an operator to facilitate operation. A miter detent and locking mechanism are also set at the bottom of the turntable and near the operator. Since these components are complicated in structure a turntable of big size is needed and, as a result, cost is increased accompanied with increasing of weight and inconvenience of operation.

### SUMMARY

To overcome these deficiencies, the following describes a miter saw which comprises a base, a turntable mounted on the base, a support provided on a first end of the turntable, a pivot member connected to the support for pivotal movement about a first horizontal axis, a supporting arm connected to the pivot member for pivoting about a second horizontal axis which is generally perpendicular to the first horizontal axis, a cutting assemble fixedly mounted on the supporting arm for pivoting about the second horizontal axis, and a bevel locking mechanism for locking the pivot member to the support. The bevel locking mechanism comprises a lever which is pivotally mounted to a second end of the turntable opposite the first end and a flexible elongate element having one end winding around the lever and the other end connecting to a bevel locking shaft which is connected between the pivot member and the support.

As another embodiment, the following further describes a miter saw comprising a base, a turntable mounted on the base for rotation about a vertical axis relative to the base, a series of recesses distributed around a periphery of the turntable, each of the recesses corresponding to a predetermined angular position of the turntable relative to the base, a support mounted on the turntable, a pivot member connected to the support for pivoting about a first horizontal axis, a supporting arm connected to the pivot member for pivoting about a second horizontal axis which is generally perpendicular to the first horizontal axis, a cutting assembly fixedly mounted to the supporting arm for pivoting about the second horizontal axis, and a miter detent device mounted to the turntable. The miter detent device comprises a lever which is pivotally mounted to the turntable, a positioning pin which is movably mounted to the turntable, a spring biased between the positioning pin and the turntable, and a flexible elongate element with one end connecting to the positioning pin and the other end winding around the lever. As will become apparent, the flexible elongate element will not be restricted by space which greatly benefits power tools such as miter saws which are integrated with multiple locking mechanisms in a narrow space of a table.

Still further, the following describes a miter saw comprising a base, a turntable mounted on the base for rotation about a vertical axis relative to the base, a support fixedly mounted on the turntable, a pivot member connected to the support for pivoting about a first horizontal axis, a supporting arm connected to the pivot member for pivoting about a second horizontal axis which is generally perpendicular to the first axis, a cutting assembly fixedly mounted on the supporting arm for pivoting about the second axis, and a miter locking device mounted on the turntable. The miter locking device comprises a handle which is connected to the turntable by a cam mechanism, a locking rod which is connected to the handle and which is axially movable, and an elastic member biased between the locking rod and the turntable when the locking rod is driven by the cam mechanism to fix the turntable with respect to the base. As will become apparent, with such a miter locking device, the elastic member will contact the base first when the locking rod is driven by the handle to move towards the base, and as the locking rod keeps moving, the elastic member will abut tightly on the base. In this manner, the miter angle of the turntable relative to the base is locked by the friction between the elastic member and the base and distortion between the base and the locking rod is avoided by the elastic deformation of the elastic member.

### BRIEF DESCRIPTION OF THE DRAWINGS

The subject miter saw will become apparent from the following detailed description illustrated in the accompanying drawings, wherein:

FIG. 1 is a perspective view of an exemplary embodiment of a miter saw constructed in accordance with the present invention;

FIG. 2 is an exploded view of an exemplary miter detent device of the miter saw of FIG. 1;

FIG. 3 is a bottom view of an exemplary turntable of the miter saw of FIG. 1;

FIG. 4 is a perspective view of exemplary components of the miter saw of FIG. 1;

FIG. 5 is a sectional view of the exemplary turntable and pivot member of the miter saw of FIG. 1;

FIG. 6A is a schematic view of a first exemplary miter locking device of the miter saw constructed according to the present invention; and

FIG. 6B is a schematic view of a second exemplary embodiment miter locking device of the miter saw constructed according to the present invention.

### DETAILED DESCRIPTION

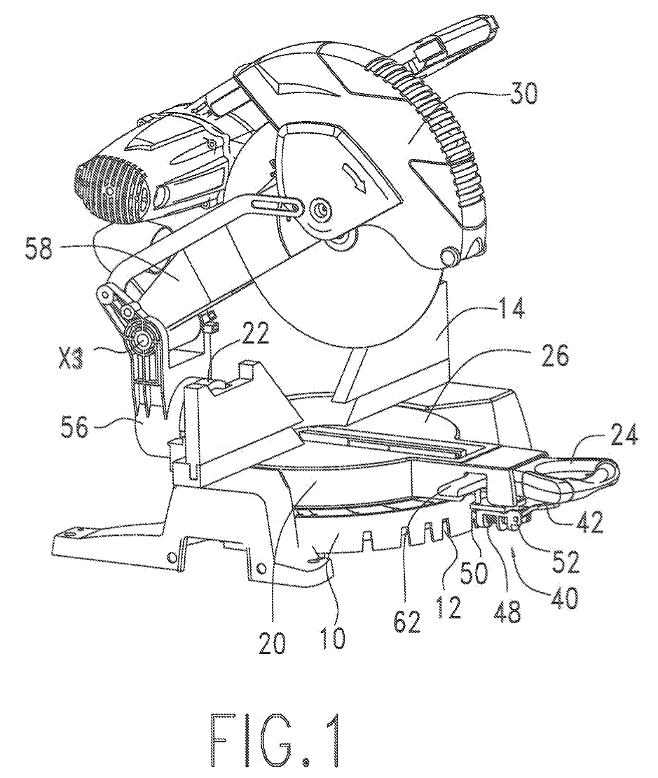

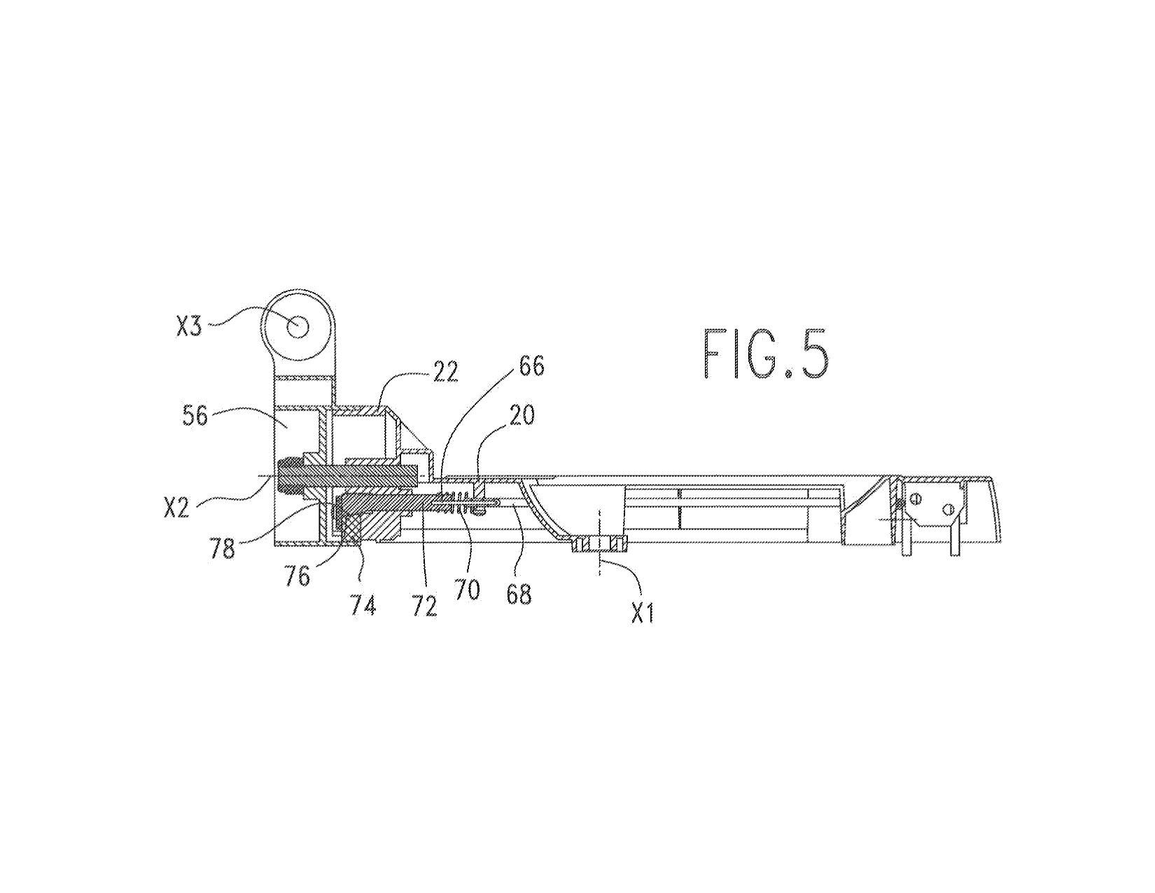

Referring now to the figures, illustrated in FIG. 1 and FIG. 5 is a miter saw comprising a base 10 and a turntable 20 mounted on the base 10 for rotation about a vertical axis X1. A support 22 is fixed at the rear of the turntable 20, and a pivotal support 56 is connected with the support 22 for pivotal movement about a first horizontal axis X2 which generally lies within a support surface 26 of the turntable 20. A supporting arm 58 is connected to the pivotal support 56 for pivoting about a second horizontal axis X3 which is generally perpendicular to the first horizontal axis X2. A cutting assembly 30 is fixedly mounted on the supporting arm 58 for rotation about the second horizontal axis X3 between a cutting position and a non-cutting position. A fence assembly 14 is vertically installed on the base 10 against which a workpiece is to be positioned to be cut.

Multiple recesses 12 are distributed around the base 10 circumferentially. Each of the recesses 12 is positioned so as to correspond to a predetermined miter angle of the turntable 20 relative to the base 10. A miter detent device 40 is mounted to a front end of the turntable 20 near the operator and includes a positioning pin 50 which is axially movable between a first position and a second position when actuated by a lever 42. In the first position, the positioning pin 50 inserts into one of the recesses 12 under biasing of a spring 48 to fix the miter saw in a desired angular position. In the second position, the positioning pin 50 disengages the recesses 12 to thereby allow the turntable 20 to be rotated freely.

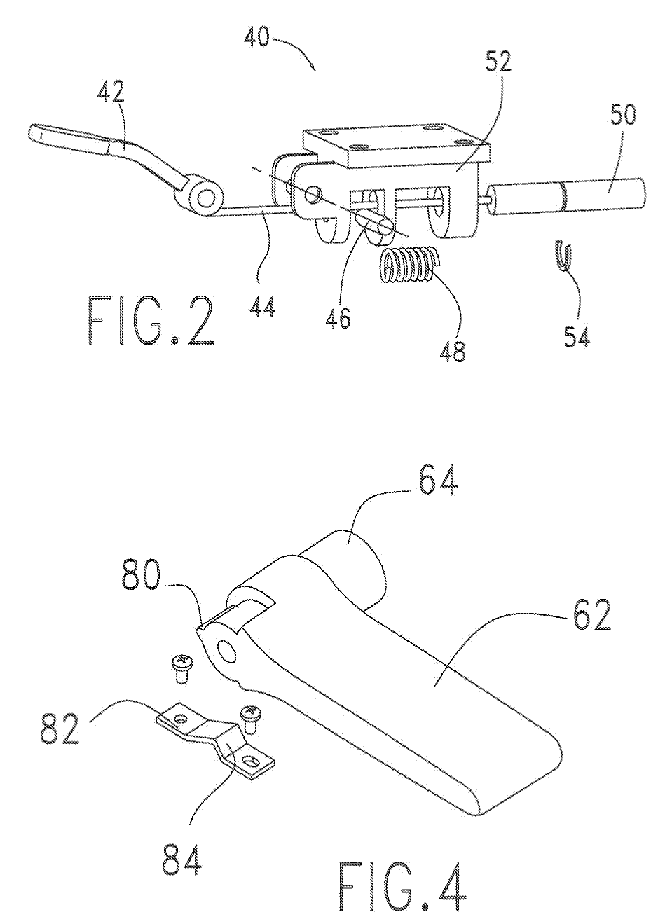

Referring to FIG. 2, the miter detent device 40 further comprises a bracket 52 mounted to the turntable 20, the lever 42 which is pivotally mounted to the bracket 52 via a shaft 46, and the positioning pin 50 which is movably mounted to the bracket 52. An elastic ring 54 is fixedly mounted on the positioning pin 50 and the spring 48 is compressed and mounted between the positioning pin 50 and the bracket 52. One end of a first cable or rope 44 connects to the positioning pin 50 and the other end thereof winds around a rotatable rod which is fixedly connected to the lever 42. With pivoting of the lever 42, the rope 44 winds around or releases from the lever rod and thus causes the positioning pin 50 to be pulled to disengage from the recesses 12 or to be released to insert into one of the recesses 12 so that the miter angle of the turntable 20 relative to the base 10 is adjustable.

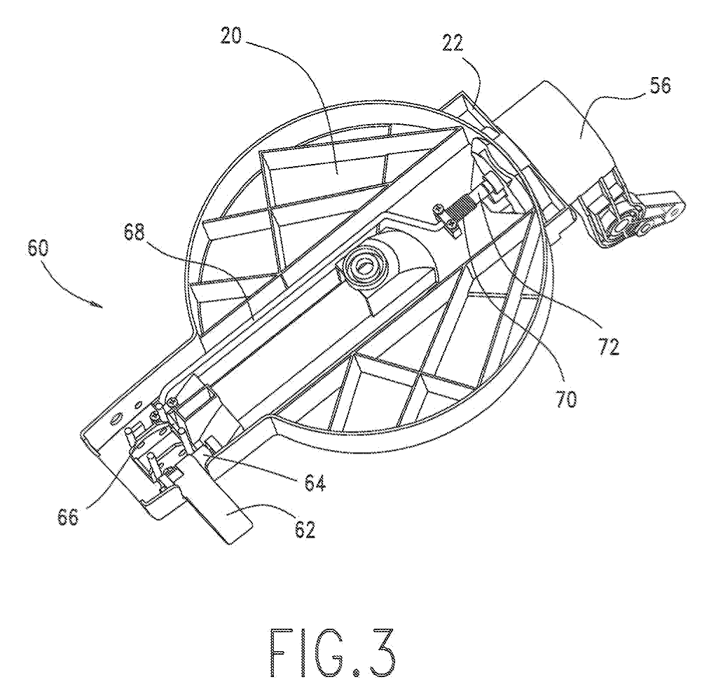

As shown in FIG. 1 and FIG. 3, a bevel locking device 60 comprises a bevel locking lever 62 which is mounted to the front end of the turntable 20 near the operator and a rotating shaft 64 which is fixed on the bevel locking lever 62. A second cable or rope 66 extends through an orientation tube 68 and connects the bevel locking lever 62 and the pivot support 56. One end of the second rope 66 winds around a rotating shaft 64 and the other end thereof connects to a bevel locking shaft 72. In an exemplary embodiment, the second rope 66 connects to the bevel locking shaft 72 without extending through the orientation tube 68. Guiding devices such as guide channels, through holes, or the like may be used to guide the second rope 66 to walk around obstructs. When used, the orientation tube 68 may be a flexible tube, or a rigid tube with a certain shape, and the tube 68 can be constituted by a combination of multiple tubes. The first rope 44 and the second rope 66 are preferably twistable and axially non-extendable, for example being constructed from steel wires.

The bevel locking lever 62 is movable between at least two positions. In a first position the second rope 66 winds tightly around the shaft 64 and the bevel locking shaft 72 is tensed such that the pivot support 56 bears against the support 22 and is locked in a desired angular bevel position by the friction between the pivot support 56 and the support 22. In a second position the second rope 66 releases from the shaft 64 and the bevel locking shaft 72 moves axially towards the pivot support 56 under the biasing of a spring 70 and thereby allows the pivot support 56 to rotate with respect to the support 22, and thus the angle of the cutting assembly 30 with respect to the support surface 26 is changable. This operation is described in greater detail below.

Referring to FIG. 4, there is a protrusion 80 on the bevel locking lever 62. The protrusion 80 comes into contact with an inclined surface 84 of a leaf spring 82 mounted on the turntable 20 when the lever 62 rotates to one of the two positions described above. In this manner, the lever 62 is limited by the leaf spring 82 and is kept from rotating further.

FIG. 5 shows details of the bevel locking mechanism. The second rope 66 extends through the orientation tube 68 and connects with the bevel locking shaft 72. The spring 70 is biased between the locking shaft 72 and the turntable 20. There is a slant 76 at the back end-portion of the locking shaft 72. The slant 76 abuts an inclined surface 78 of a locking block 74 which is mounted within the pivot support 56. The locking block 74 is pressed between the locking shaft 72 and the pivot support 56 as the locking shaft 72 is pulled by the second rope 66 and thus the movement of the bevel locking shaft 72 is restricted such that the pivot support 56 is locked by the friction between the locking block 74 and the pivot support 56. The locking shaft 72 moves towards the pivot support 56 under biasing of the spring 70 as the rope 66 is released and the pressure between the slant 76 and the inclined surface 78 disappears thereby allowing the pivot support 56 to be rotatable with respect to the support 22.

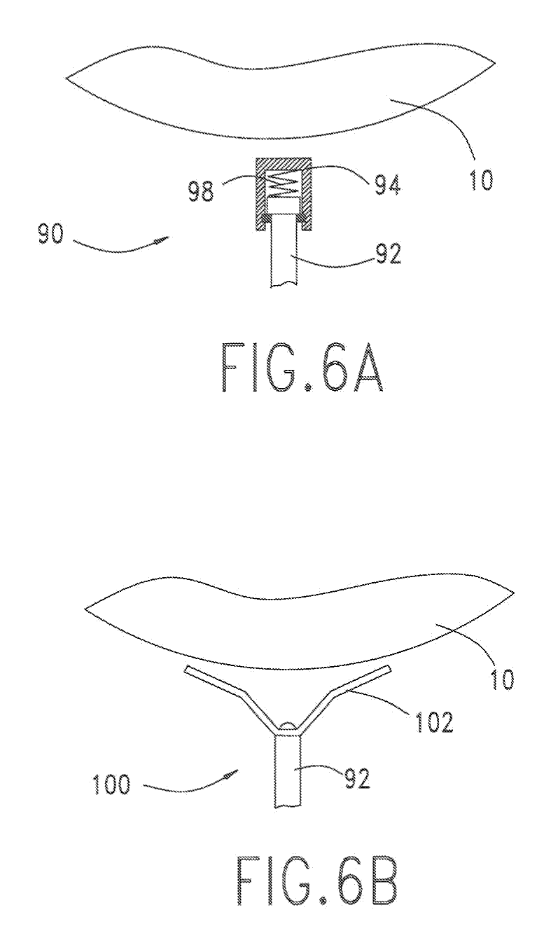

Referring to FIG. 1 and FIG. 6A, a first embodiment of a miter locking device 90 comprises a handle 24 which is connected to the turntable 20 through a cam mechanism (not shown) and a locking rod 92 which is axially movable when driven by the handle 24. The tail end of the locking rod 92 is connected to a press element 94 with a spring 98 compressed therebetween. When the locking rod 92 is driven by the handle 24 to move towards the base 10 the press element 94 will abut the side surface of the base 10 and, as the locking rod 92 keeps moving, the spring 98 is pressed to transfer further press force to the press element 94. In this manner, the miter angle of the turntable 20 relative to the base 10 is locked by the friction between the press element 94 and the base 10. Distortion between the base 10 and the locking rod 92 is avoided through the elastic deformation of the spring 98.

FIG. 1 and FIG. 6B show a further embodiment of a miter locking device 100 which comprises a locking rod 92 with one end fixedly connected to a flexible pressure piece 102. The flexible pressure piece 102 will press against the base 10 when driven by the locking rod 92 and thus the turntable 20 is locked to the base 10.

The above described preferred embodiments are intended to illuminate the principle of the present invention but not to limit its scope. It can be easily understood for those skilled in the art that many other modifications and variations of these preferred embodiments will be apparent and may be made without departing from the spirit and the scope of the invention as defined in the following claims.

What is claimed is:

1. A miter saw, comprising:
a base;
a turntable mounted on the base;
a support provided on a first end of the turntable;
a pivot member connected to the support for pivotal movement about a first horizontal axis;
a supporting arm connected to the pivot member for pivoting about a second horizontal axis which is generally perpendicular to the first horizontal axis;
a cutting assemble fixedly mounted on the supporting arm for pivoting about the second horizontal axis; and
a bevel locking mechanism for locking the pivot member to the support wherein the bevel locking mechanism comprises a lever which is pivotally mounted to a second end of the turntable opposite the first end, a bevel locking shaft connected between the pivot member and the support, and a flexible elongated element having one end windable about the lever and another end connected to the bevel locking shaft.

2. The miter saw as claimed in claim 1, wherein the flexible elongated element is axially non-extendable.

3. The miter saw as claimed in claim 1, comprising a guide device through which is passed the flexible elongated element.

4. The miter saw as claimed in claim 1, wherein the lever of the bevel locking mechanism is movevable between a first position, whereat the bevel locking shaft is pulled tightly by the flexible elongated element to lock the pivot member to the support, and a second position, whereat the flexible elongate element is released and the bevel locking shaft moves to allow the pivot member to be rotatable freely relative to the support.

5. A miter saw, comprising:
a base;
a turntable mounted on the base for rotation about a vertical axis relative to the base;
a series of recesses distributed around a periphery of the turntable, each of the recesses corresponding to a predetermined angular position of the turntable relative to the base;
a support mounted on the turntable;
a pivot member connected to the support for pivoting about a first horizontal axis;
a supporting arm connected to the pivot member for pivoting about a second horizontal axis which is generally perpendicular to the first horizontal axis;
a cutting assembly fixedly mounted to the supporting arm for pivoting about the second horizontal axis; and
a miter detent device mounted to the turntable wherein the miter detent device comprises a lever which is pivotally mounted to the turntable, a positioning pin which is movably mounted to the turntable, a spring biased between the positioning pin and the turntable, and a flexible elongated element having one end connected to the positioning pin and another end windable about the lever.

6. The miter saw as claimed in claim 5, wherein the miter detent device comprises a bracket mounted on the turntable and the positioning pin is movably mounted on the bracket.

7. The miter saw as claimed in claim 5, wherein the lever is movable between a first position, whereat the flexible elongated element is unwound from the lever such that the positioning pin engages with one of the recesses, and a second position, whereat the flexible elongated element is wound about the lever such that the positioning pin is disengaged from the recesses.

8. A miter saw, comprising:
a base;
a turntable mounted on the base for rotation about a vertical axis relative to the base;
a support fixedly mounted on the turntable;
a pivot member connected to the support for pivoting about a first horizontal axis;
a supporting arm connected to the pivot member for pivoting about a second horizontal axis which is generally perpendicular to the first axis;
a cutting assembly fixedly mounted on the supporting arm for pivoting about the second axis; and
a miter locking device mounted on the turntable wherein the miter locking device comprises a handle which is connected to the turntable by a cam mechanism, a locking rod which is connected to the handle and which is axially movable, and an elastic member biased between the locking rod and the turntable when the locking rod is driven by the cam mechanism to fix the turntable with respect to the base.

9. The miter saw as claimed in claim 8, comprising a press element mounted to one end of the locking rod and a spring biased between the locking rod and the press element.

10. The miter saw as claimed in claim 8, wherein said elastic member is a flexible pressure piece.
